(19) United States
(12) Patent Application Publication
(10) Pub. No.: US 2016/0008995 A1
(43) Pub. Date: Jan. 14, 2016

(54) DEVICE AND METHOD FOR CUTTING A FROZEN FOOD STRAND INTO SLICES

(71) Applicant: Uwe Reifenhaeuser, Flammersfeld (DE)

(72) Inventor: Uwe Reifenhaeuser, Flammersfeld (DE)

(21) Appl. No.: 14/686,683

(22) Filed: Apr. 14, 2015

(30) Foreign Application Priority Data
Apr. 15, 2014 (DE) DE102014105352.4

(51) Int. Cl. B26D 1/16; B26D 7/01; B26D 7/06; B26D 5/08

(52) U.S. Cl. CPC B26D 1/16; B26D 5/08; B26D 7/01; B26D 7/06

(57) ABSTRACT

A device for cutting a frozen food strand into slices including a machine frame; a cutting device with a cutting tool configured as a circular saw blade supported in the machine frame, wherein the cutting tool is rotatable about its center axis and moveable in a cutting plane defined by the circular saw blade; and a feed portion for the food product to be cut from which feed portion the food product is moveable towards the cutting device so that successive slices are cutable from the food product wherein the food product is moveable in the feed portion into a feed direction which extends perpendicular to the cutting plane, wherein the circular saw blade is supported drivable in rotation at an arm that is supported in or at the machine frame, and wherein the circular saw blade continuously rotates with the arm about a rotation axis of the arm.

### RELATED APPLICATIONS

This application claims priority from and incorporates by reference German Patent Application DE 10 2014 105 352.4 filed on Apr. 15, 2014.

### FIELD OF THE INVENTION

The present invention relates to a device for cutting a frozen food product strand into slices.

### BACKGROUND OF THE INVENTION

The method and the device described supra are already known from practical applications. It has proven helpful to saw frozen food products for portioning. Typically band saws are used for this purpose wherein operating them is rather risky for the operator since the cutting material has to be supported by hand so that businesses have to pay high insurance premiums. Since the saw blades are rather thin the loss of cutting material caused by the cutting process is insignificant.

Furthermore circular saws are known for portioning frozen food products wherein large monolithic blocks with frozen material are fed to a plurality of circular saw blades which cut the blocks into strips with identical sizes. Thus, a blade plane of the circular saw blades is respectively parallel to a feed direction of the frozen blocks.

Furthermore a cutting device in particular for fish products is known from EP 0 429 711 B1 which allegedly facilitates weight precise cutting. With this cutting device the cutting process can also be performed transversal to a conveyor belt, thus transversal to the feed direction. Thus a respective cutting tool is lowered from a top side of the conveyor belt into the food product which is thus cut. In order to continuously produce plural portions of the food product a linear oscillating movement of the cutting tool is performed wherein the cutting tool continuously rises and descends wherein the food product is cut during each descent. A linear oscillating movement of the cutting tool between two extreme positions requires a directional reversal of the cutting tool which generates high inertial forces which can cause the cutting device to run rough. Furthermore a required machine configuration is rather complex.

A device for sawing block shaped frozen food products is known from DE 1188250 which teaches using circular saw blades instead of band saws. However, since an increasing diameter of the circular saw blades necessitates an increase in blade thickness for safety reasons this would soon lead to a blade thickness which is high enough to render the sawing loss unacceptable so that a sawing device is proposed in the publication document recited supra which includes two saw blades that cut in the same plane and which are driven in opposite directions at identical speeds. In order to able to saw a food material block with the thickness D thus circular saw blades are used that engage from opposite sides and which respectively only have to penetrate half the thickness D of the block in order to eventually produce two saw gaps that extend over the entire thickness D. The two circular saw blades of the known device are stationary and the food product block to be sawed is moved forward in its longitudinal direction parallel to a plane of the circular saw blades. In order to generate more than one saw cut through the food product block in a single feed stroke plural circular saw blades are arranged offset in an axial direction respectively on a circular saw blade shaft.

DE 10 2010 002 279 A1 discloses a machine in particular for cutting meat into slices, wherein the meat can also be partially frozen or completely frozen. Thus, a circular blade is supported at a swing arm wherein the blade is supported at the swing arm so that the blade is drive able in rotation, wherein the swing arm rotates about a rotation axis that is arranged outside of the cutting cross section and that is oriented parallel to a feed device (orbital drive). In order to generate a saw effect the ratio of the speed of the circular blade to the speed of the swing arm is at least 6 to 1, advantageously at least 8 to 1 for frozen food products. However, the known machine is a cutting machine and no circular saw since no chips are generated during a separation process and the circular blade does not have any teeth that develop a chipping effect in a circumferential direction of the blade and which can cause a material removal from the cutting gap. Thus, the machine according to DE 10 2010 002 279 A1 is of a different genus than the subject matter of the instant application.

### BRIEF SUMMARY OR THE INVENTION

Thus, it is an object of the instant invention to improve the method and the device described supra so that the recited problems do not occur.

The object is achieved by a device for cutting a frozen food strand into slices, the device including a machine frame; a cutting device with a cutting tool configured as a circular saw blade supported in or at the machine frame, wherein the cutting tool is rotatable about its center axis and moveable in a cutting plane defined by the circular saw blade; and a feed portion for the food product to be cut from which feed portion the food product is moveable towards the cutting device so that successive slices are cutable from the food product wherein the food product is moveable in the feed portion into a feed direction which extends perpendicular to the cutting plane, wherein the circular saw blade is supported drivable in rotation at an arm that is supported in or at the machine frame, and wherein the circular saw blade continuously rotates or oscillates with the arm about a rotation axis of the arm which rotation axis is fixated at the machine frame.

The object is also achieved by a method for cutting a frozen food product strand into slices, the method including the steps inserting the food product to be cut in a feed portion of a device for cutting; moving the food product out of the feed portion forward to a cutting device of the device so that successive slices are cut off by a cutting tool configured as a circular saw blade from the product at its forward end; rotating the circular saw blade about its center axis and moving it in a cutting plane defined by the circular saw blade; and moving the food product in a feed direction that extends perpendicular to the cutting plane during feeding, wherein an arm which supports the center axis of the circular saw blade is rotated about a rotation axis that is fixated at the machine frame, or wherein the arm performs an oscillating movement about the rotation axis.

The object is achieved by a device in which the circular saw blade is supported drive able in rotation at an arm that is supported in or at the machine frame and wherein the circular saw blade continuously rotates with the arm about a rotation axis of the arm (oscillates). This way the saw blade is either always moved circumferentially in one direction so that a directional change that is required for a translatoric back and forth movement is omitted. The arm that can also be designated as swing arm performs a circumferential movement about its rotation axis that is fixated at the frame. The saw blade is typically arranged at an end of the arm which end is arranged opposite to the rotation axis that is fixated at the frame and the saw blade additionally rotates about its own axis of rotation. A cutting device of this type runs smoothly and has a favorable configuration from a cost end and design point of view. Alternatively the swing arm can also be moved in an oscillating manner which implements a space saving motion without limiting a maximum possible cutting cross section. Additionally the food product in both alternatives is not moved by hand like in the prior art but the feeding of the food product is also provided in an automated manner which increases operational safety, reduces a risk of injury and eventually has a favorable effect on insurance premiums.

According to a particularly advantageous embodiment of the device according to the invention a thickness of the circular saw blade at least in a portion of teeth, advantageously in an annular portion which extends from an outer diameter of the circular saw blade by 20 mm to 30 mm radially towards a center axis is less than 2 mm, advantageously less than 1.8 mm and further advantageously less than 1.7 mm, additionally or alternatively the diameter of the circular saw blade should be more than 500 mm, advantageously more than 550 mm, further advantageously more than 600 mm.

During the sawing process pieces of the food product are cut out in a width of the individual teeth of the saw blade. These pieces are waste material and are not used in the food product. Therefore the intention is to keep the sawing losses as small as possible. So far mostly band saws were used. The main reason being that their saw blades are characterized by a small thickness between 0.8 mm and 1.2 mm. Contrary thereto known circular saw blades have a thickness of approximately 4 mm for technical reasons which renders using a circular saw for cutting frozen food products uneconomical due to the high saw cutting loss. Even considering that band saws cause high insurance premiums due to the high risk of injury band saws remain more economical than circular saws that are known in the art.

By reducing the thickness of the circular saw blade in a relevant outer portion of the circular saw blade to half the prior thickness at the most or even less significantly reduces the sawing loss so that using a device according to the invention becomes interesting in particular for safety reasons.

Arguments against reducing the thickness of the circular saw blade so far were a lack of stability or increased vibrations of the circular saw blade which caused a high level of noise to be generated. In order to typically reduce noise emissions incisions are introduced into the circular saw blade in the prior art wherein the incisions extends in radial direction from an outer circumference and have several centimeters in length (so called “clef”). This prevents a generation of resonances. Furthermore damping is provided at the incisions by friction with material penetrating the incisions. In the circular saw blade according to the invention with low thickness however it has become apparent that these incisions are counterproductive so that the circular saw blades according to the invention do not have such incisions. They are rather made from a continuous metal disc outside of the teeth.

It is furthermore advantageously when a width of the teeth measured in a circumferential direction of the circular saw blade is less than 20 mm, advantageously less than 15 mm, further advantageously less than 12 mm, most advantageously less than 10 mm and/or a distance of cutting edges of respective adjacent teeth is less than 22 mm, advantageously less than 20 mm, further advantageously less than 18 mm. A reduced width of the teeth reduces a resistance of the circular saw blade when entering the frozen food product to be cut. Thus it is furthermore possible to arrange more teeth at a circumference of the circular saw blade which increases a number of cutting edges arranged at the teeth and thus increases cutting performance of the circular saw blade. Furthermore the saw cut becomes finer.

Advantageously cutting edges of teeth of the circular saw blade are made from hard metal, advantageously from hard metal inserts. Thus, portions of the circular saw blade that are loaded the most during cutting of the food product are particularly strong and wear resistant. When cutting edges of inserts are made from hard metal they can be easily replaced during maintenance.

Thus it is furthermore advantageous when a chipping surface extending from a cutting edge of a tooth is in alignment with a front surface of the respective tooth which front surface adjoins in a direction of a base of a chipping cavity or the chipping surface is in a common plane with the front surface of the respective tooth so that forming chips move into the chipping cavity without restriction or deflection.

Alternatively it can be provided that the chipping surface extending from a cutting edge of the tooth forms an angle with a back side of the insert oriented away from the chipping cavity wherein the angle is between 25° and 35°, advantageously between 28° and 32°.

It has proven particularly advantageous that a wedge angle of the teeth of the circular saw blade is between 48° and 68°, advantageously between 55° and 60° and/or a chip angle of the teeth of the circular saw blade is between 15° and 35°, advantageously between 23′ and 30° and/or a free angle of the teeth of the circular saw blade is between 4° and 16°, advantageously between 8° and 12°.

When a difference between the outer diameter of the circular saw blade and a diameter of a circle on which the bases of the chip cavities are arranged is at least 20 mm, advantageously at least 25 mm, this yields a relatively long teeth and a long chipping cavity. This is advantageous because the chipped material shall be collected in the chipping cavity in order to prevent a smearing during the cutting process. Thus it is positive when a chipping cavity volume is larger than a volume of chipped material.

With respect to a force introduction of the hard metal inserts into the circular saw blade it is particularly advantageous when a base portion of the hard metal inserts oriented towards a rotation axis of the circular saw blade is supported by a lug towards an end section of a front surface of the tooth oriented away from the chipping cavity. The inserts that are typically soldered on can typically be supported at the support lug under load which renders the soldered joint more durable.

According to a particularly advantageous embodiment of the invention a side surface of the circular blade that is oriented towards the slice of the food product that is being cut extends at an angle between 2° and 0.2°, advantageously at an angle between 1° and 0.4° relative to an opposite side surface of the circular blade so that a thickness of the saw blade decreases in radial outward direction wherein the opposite side surface of the circular saw blade advantageously extends at an angle of 90° relative to the rotation axis. Accordingly the circular saw blade respectively extends in a cone shape on one side starting from its center and moving to the outer edges. Thus, the circular saw blade has a reduced thickness at its outer circumference compared to its center. Therefore the circular saw blade penetrates a frozen food product much more easily due to a reduced initial resistance.

With respect to a configuration of the circular saw blade it is furthermore advantageous when the circular saw blade has parallel extending side surfaces in an outer ring portion which extends from an outer diameter of the circular saw blade radially towards the center axis and in an inner circular portion which extends radially outward from a center point of the circular saw blade, wherein the side surfaces of the circular saw blade extend at an angle relative to each other in an inner ring portion which extends between the outer ring portion and the inner circular portion. The outer ring portion is thus typically configured thinner than the remaining portions so that a first entry of the circular saw blade into the food product is simplified. During a further penetration of the circular saw blade into the food product also the one sided beveled portion of the circular saw blade penetrates the food product wherein the beveled portion acts like a wedge which presses the nascent slice away from the food strand. The beveled portion thus opens a cutting gap in the food product which improves the cutting process as such.

Thus it can be an additional advantage when the hard metal inserts protrude in axial direction beyond at least one of the two side surfaces of the circular blade, thus advantageously by an amount between 0.05 mm and 0.25 mm further advantageously between 0.15 and 0.20 mm. The interval between 0.20 mm and 0.25 mm can also be well suited. Thus during the cutting process a minimum gap is created between the side surfaces of the circular blade and the cut food product which reduces or prevents a friction or sticking between the side surfaces and the food product.

In order to maintain durability of the circular saw blade which is typically configured very thin and very hard so that a fracture can occur under excessive forces it has proven advantageous to provide an automatic shut off and/or a reduction of an angular velocity of the arm which are respectively activatable when a threshold for a resistance of the arm during passage of the circular saw blade through the food product is exceeded. In particular when a circular saw blade has been in use for a while its sharpness can decrease so that cutting performance decreases as well. For a constant speed of the arm the chipping performance of the circular saw blade decreases with decreasing sharpness, so that the “feed velocity” through the food product is reduced so that a force applied by the arm upon the circular saw blade is significantly increased so that a fracture of the circular saw blade can occur. A rapid increase of the force impacting the circular saw blade can also occur when foreign objects for example made from metal are disposed in the food product. In order to prevent a fracture of the circular saw blade the automatic shutdown is activated according to the invention so that the arm at which the circular saw blade is supported is either reduced in its angular velocity or stopped completely besides a further rotation caused by inertia, wherein the circular saw blade can continue to rotate. As stated supra a speed reduction of the arm can also be provided so that the arm rotates more slowly hence forth so that the circular saw blade has more time to perform its cut. A combined embodiment of the device according to the invention with a speed reduction for the arm and an automatic shutdown of the arm is also conceivable.

It is furthermore feasible to alternatively or additionally provide a speed reduction and/or an automatic shutdown for the circular saw blade which is also activatable when a threshold value for a resistance of the circular saw blade is exceeded during the cutting process. Typically the circular saw blade and the arm are provided with individual separately controllable drives. A measurement of a torque presently impacting the circular saw blade can be provided by measuring the power draw of the respective drive motor. The same applies for measuring the torque currently impacting the arm wherein the power draw of the drive motor of the arm is used. A measurement of an angular velocity of the arm and/or of the circular saw blade can be performed using a respective impulse generator which is arranged in a drive train of the arm and/or of the circular saw blade.

According to another independent aspect of the invention a cutting material support for supporting the food product to be cut is provided at a rear end of the food product in feed direction wherein at least an upper engagement element of the cutting material support can be brought into form locking engagement with a surface of the food product that is oriented away from a base of the feed portion. Additionally a down holder with at least two contact portions is provided wherein the down holder can be brought in contact with a surface of the food product that is oriented away from the feed portion at the contact portion, wherein adjacent contact portions viewed perpendicular to the feed direction and parallel to a base of the feed portion have a distance from one another which corresponds to a maximum width of an upper engagement element so that the upper engagement element and the down holder are in direct contact with the food product until a last slice of the food product is cut off. This way in particular a leftover of the food product to be cut which remains at an end of the cutting process and which typically tends to flip due to its reduced length is pressed down by the down holder and supported by the cutting material support so that a significantly improved fixation of the left over piece is provided during the cutting process. This combination of the down holder with the cutting material support can also be used for other cutting machines, for example for machines which do not have an orbital drive of the cutting device or which are equipped with a knife instead of a saw blade.

Alternatively or additionally the device according to the invention can be provided with a cutting material support for supporting the food product to be cut at its rear end in cutting direction wherein at least an upper engagement element of the cutting material support can be brought in form locking engagement with a surface of the food product that is oriented away from a base of the feed portion. In order to fixate the frozen strand shaped food product during the cutting process particularly well at least one lower engagement element is provided according to the invention wherein the lower engagement element can be brought into form locking engagement with a surface of the food product that is oriented towards the base of the feed portion. Therefore the at least one upper engagement element and the at least one lower engagement element can be considered as a pincer by which the food product to be cut is supported at its top side and at its bottom side. Due to the fact that the frozen food product to be cut is very slippery and typically includes bones and has an irregular shape it is helpful when special emphasis is put on fixating the food product during the cutting process of the food product. In particular a good fixation of the cutting material is important in order to prevent a wedging of the saw blade in the sawing gap due to an unintentional displacement of the food strand different from the feed direction which could fracture the saw blade. Also this pincer shaped configuration of the cutting material support according to the invention can be used for all cutting machines independently from the type of cutting device or other elements. For this purpose the cutting material support and/or the channel base can be provided with small ribs that are offset from one another and which extend parallel to the feed direction and which prevent a slipping or rotation of the frozen and thus very hard food product.

With respect to fixating the food product it can furthermore be advantageous when at least one upper engagement element and/or at least one lower engagement element is respectively arranged at one arm, wherein both engagement elements are advantageously pivotable about a pivot axis that is oriented perpendicular to the feed direction and parallel to a base of the feed portion in order to impart a clamping force from opposite surface portions upon the food product that is arranged between the engagement elements. Imparting the clamping force upon the food product facilitates reliably supporting the food product and establishing a form locking connection.

Advantageously the cutting material support includes a stop element that is adjustable in feed direction wherein the engagement elements are arranged upstream of the stop element in feed direction. As a function of an individual adjustment of a precise position of the stop element this provides a defined distance between an end of the food product to be cut and the engagement portion of the engagement elements. Thus it can be excluded that the engagement elements engage at undesirable locations and impair the cutting process.

With respect to an embodiment of the cutting material support according to the invention it has proven particularly advantageous when the cutting material support includes a drive element that is arranged between the at least one upper and lower engagement element at distal ends of the arms, wherein the drive element facilitates moving the engagement elements closer to each other by opposite pivoting of the arms, wherein the drive element is advantageously configured as piston-cylinder-unit, advantageously as a pneumatic cylinder or hydraulic cylinder. This provides a mechanism which facilitates applying a tension force upon the food product to be cut.

Additionally the cutting material support of the device has proven particularly useful when it includes a linked rectangle whose corners are formed by both pivot axes of the arms and by two links between ends of the arms that are oriented away from the engagement elements and opposite ends of the drive element wherein one side of the linked rectangle is formed by a drive element with variable length and two adjoining sides of the linked rectangle are formed by sections of the arms wherein furthermore both pivot axes of the arms are arranged at a bearing block that is moveable in feed direction by a feed device. The linked rectangle has proven particularly useful in the device according to the invention for cutting frozen food products since the insertion portion is typically provided with a downward tapering groove in which the food product is run. Thus, the groove for example has a cross section in the form of a trapeze with equal arm length, wherein the short side is arranged at the base of the groove and the long side is arranged at the top of the groove. This groove geometry facilitates that an irregular shaped food product for example configured as a thinning beef leg disc continuously has sufficient support from the groove walls extending at a slant angle so that the food product is laterally supported. Since the arms of the cutting material support include a linked rectangle the arms can impart a pressing force upon the food product, wherein the arms are vertically moveable together. Thus, the engagement elements can follow the position of the food product in vertical direction, in particular when a cross section of the food product changes in the portion of the cutting tool while the cutting process progresses.

With respect to the engagement elements it has proven advantageous that at least one of the engagement elements is configured as a separate element and connected with the cutting material support in a disengageable manner, advantageously in that it is arranged at the associated arm in a disengageable manner. Thus, the engagement elements are replaceable in a quick and simple manner, so that engagement elements with various geometries can be used in particular as a function of respective requirements. The engagement element is in particular made from mandrels or teeth which engage the food product and a component at which the mandrels or teeth are arranged.

Last not least it is appreciated with respect to the device according to the invention that the various features of the dependent claims can be implemented individually by themselves or in any combination in embodiments of the invention.

The object is also achieved by a method including the following feature:

e) rotating an arm which supports a center axis of the circular saw blade about a rotation axis d that is fixated at the frame or performing an oscillating movement about the rotation axis.

The method according to the invention is characterized by the advantages recited supra in a context with the device according to the invention and is furthermore implementable in a particularly simple manner with a device of this type according to the invention.

With respect to details of the method it is provided that a speed n_{K} of the circular saw blade is selected relative to the speed n_{A} or angular velocity of the arm at least large enough so that chips which are generated during a pass through of a tooth through the saw gap that is generated in the food product to be cut have a volume which is smaller than a volume of a chipping cavity that is arranged between two adjacent teeth wherein the speed of the circular saw blade is advantageously greater than 1800 rpm, further advantageously greater than 2000 rpm. By adapting the two speeds in the manner recited supra it is provided that the chipped material can be arranged in the chip cavities before it is thrown out of the chip cavities during rotation of the circular blade. Thus, a smearing of chipped material onto the circular saw blade surface is prevented during the cutting process. The speed or the oscillation frequency of the arm should therefore advantageously be greater than 30 per minute, further advantageously greater than 50 per minute even more advantageously greater than 100 per minute.

It is advantageously provided that the rotation of the oscillating movement of the arm is switched off when exceeding a threshold value for a resistance of the arm when the circular saw blade passes through the food product. As stated supra a risk of breaking the circular saw blade is thus minimized.

It is also possible that the speed n_{A} of the arm is reduced when exceeding a resistance threshold for the arm when the circular saw blade passes through the food product.

It is furthermore advantageous when an upper engagement element of a cutting material support is brought into form locking engagement at a rear end of the food product in feed direction with a surface of the food product that is oriented away from a base of the feed portion and a down holder is brought in contact with a surface of the food product oriented away from the base of the feed portion at a forward end in feed direction wherein the upper engagement element and the down holder are in direct contact with the food product until a last slice of the food product is cut off. This yields the advantage recited supra that in particular a residual of the food product that remains at the end of the cutting process and which typically tends to tip due to its short length is pressed down by the down holder and supported by the cutting material support so that a significantly improved fixation of the residual piece is provided during the cutting process.

Alternatively or additionally the method can be provided so that an upper engagement element of a cutting material support is brought into form locking engagement with a surface of the food product that is oriented away from a base of the feed portion at an end of the food product that is arranged in the rear in feed direction, wherein a lower engagement element is brought into form locking engagement with a surface of the food product that is oriented towards the base of the feed portion at a rear end in feed direction. This yields the advantages associated in particular with the device described supra in an analogous manner.

### BRIEF DESCRIPTION OF THE DRAWINGS

The method according to the invention and the device according to the invention are subsequently described in more detail with reference to an embodiment illustrated in drawing figures, wherein:

FIG. 1 illustrates a three dimensional view of a cutting device according to the invention;

FIG. 2 illustrates an enlarged view of the device of FIG. 1 in a portion of the cutting frame;

FIG. 3 illustrates a view of the circular saw blade of FIG. 1;

FIG. 4 illustrates a sectional view of the circular saw blade of FIG. 3,

FIG. 5 illustrates another sectional view of the circular saw blade of FIG. 3;

FIG. 6 illustrates an enlarged view of the circular saw blade in a portion of the teeth;

FIG. 6a illustrates an enlarged view of an alternative circular saw blade in a portion of the teeth;

FIG. 7 illustrates a vertical sectional view of the device of FIG. 1 in the portion of the circular saw blade;

FIG. 8 illustrates a three dimensional view of the cutting material support FIG. 1,

FIG. 9 illustrates a three dimensional view of an alternative cutting material support;

FIG. 10 illustrates a front view of the cutting material support of FIG. 1;

FIG. 11 illustrates a rear view of the cutting material support of FIG. 1;

FIG. 12 illustrates a three dimensional view of a device according to the invention with an alternatively configured down holder and cutting material support;

FIG. 13 illustrates an enlarged representation of the device of FIG. 12 in a portion of the cutting frame;

FIG. 14 illustrates a three dimensional top view of the cutting material support according to the invention of FIG. 12;

FIG. 15 illustrates a three dimensional bottom view of the cutting material support of FIG. 12; and

FIG. 16 illustrates a three dimensional view of an alternative device.

### DETAILED DESCRIPTION OF THE INVENTION

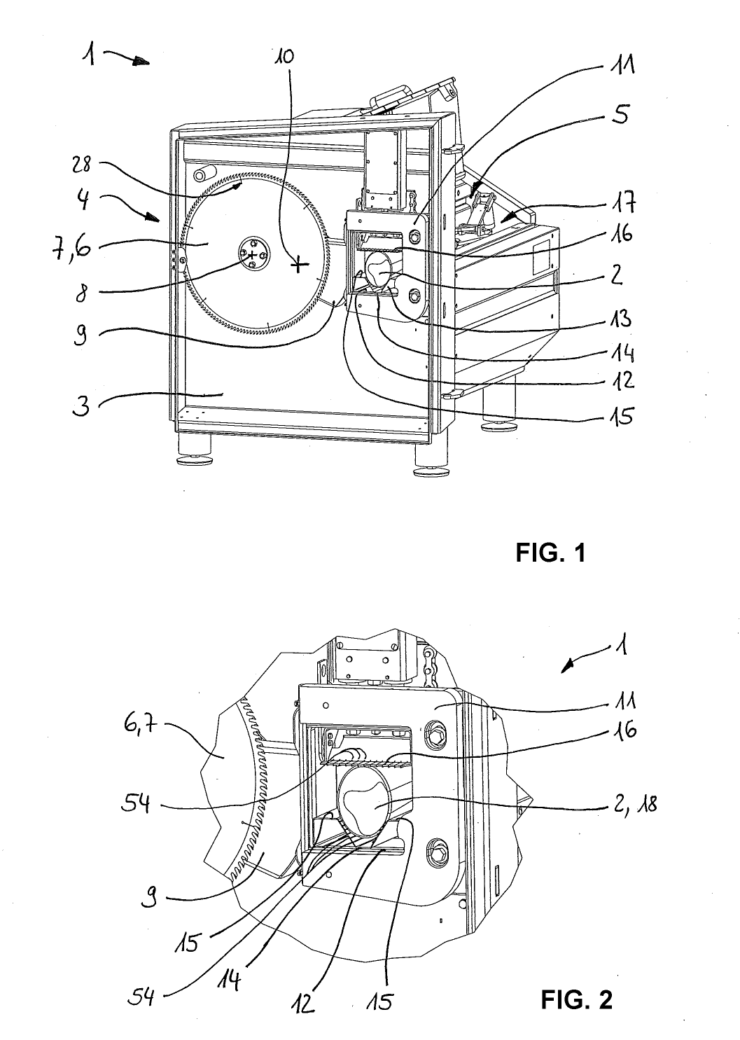

FIG. 1 illustrates a device 1 according to the invention for cutting a frozen strand of a food product 2 into slices in a three dimensional view. The device 1 includes a machine frame 3, a cutting device 4 and a feed portion 5, from which the food product 2 is moveable towards the cutting device 4 so that successive slices can be cut off from the food product. The cutting device 4 includes a cutting tool 6 configured as a circular saw blade 7, which is rotatable about a center axis 8 and which defines a cutting plane. Thus, the circular saw blade 7 is supported at an arm 9 which rotates in turn about a rotation axis that is fixated at the machine frame 3 wherein the rotation axis is covered in the figure by the circular saw blade 7 and only indicated by a cross 10 so that the circular saw blade 7 rotates about the rotation axis (cross 10) of the arms 9 and also about its own rotation axis which corresponds to its center axis 8. This way the circular saw blade 7 moves into the feed portion 5 with each rotation of the arm 9, wherein the food product 2 is continuously or cyclically moved forward into the fed portion so that slices are cut off from the food product.

FIG. 1 illustrates a cutting frame cutting frame 11 and a chute base 12 of the feed portion 5 which is provided with a groove 13 which extends over an entire length L of the chute base 12. The groove 13 has a trapezoid cross section wherein a groove base 14 is narrower than a groove top side groove top side 15. The groove shape is particularly suitable for feeding strands of food products 2 that have an irregular cross section. The food product 2 illustrated in FIG. 1 is pressed down at its front end by a down holder 16. A cutting material support 17 is visible in a rear portion of the device 1 according to the invention according to FIG. 1. The cutting material support 17 is in engagement with an end of the food products 2 which is not visible in FIG. 1. The cutting material support 17 will be de described in more detail with reference to FIGS. 8-11.

FIG. 2 is an enlarged representation of the device 1 according to FIG. 1 in the portion of the cutting frame 11 in which in particular a front end 18 of the food product 2 to be cut which lies in the groove 13 and is supported by the down holder 16 is visible quite well. Additionally it is apparent that the down holder 16 and also the groove 13 are provided with ribs 54 that extend parallel to the feed direction 36 on a side that is oriented towards the food product 2, wherein the ribs are arranged at a distance from one another. The ribs 54 have the effect that otherwise smooth surfaces of the down holder 16 and the groove 13 become significantly rougher so that an additional rotation safety of the food product 2 is provided and a risk of fracture of the circular saw blade is mitigated.

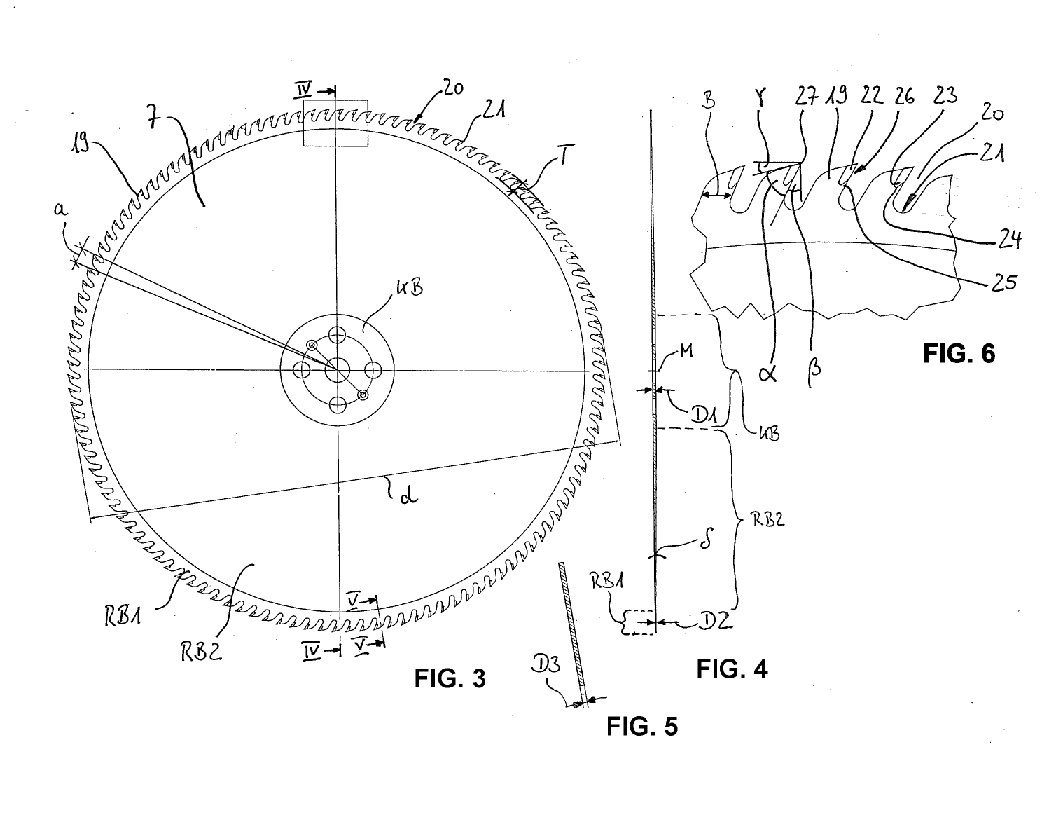

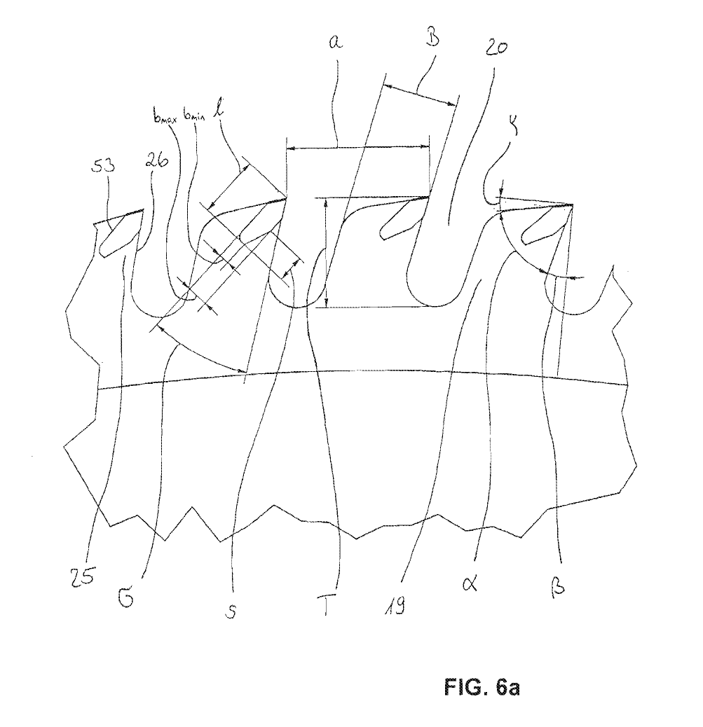

FIGS. 3-6 illustrate the circular saw blade 7 of FIG. 1 in a view with two sectional views and in a detail view. The diameter d of the circular saw blade 7 is approximately 660 mm. The illustrated circular saw blade 7 has 120 teeth 19 with a respective width B of 8.7 mm that are evenly distributed over a circumference of the circular saw blade 7. This means that adjacent teeth 19 always have the same distance a from one another. This distance a is 17.3 mm in the instant embodiment. A respective chipping cavity 20 with a rounded concave base 21 remains between adjacent teeth 19. The teeth 10 are respectively provided with hard metal inserts 22, wherein a base section 23 of the respective inserts 22 is inserted into respective recesses 24 of the teeth 19 and welded. In FIG. 6 individual teeth 19 of the circular saw blade 7 are illustrated enlarged so that their configuration is visible quite well. The recesses 24 in the teeth 19 are arranged so that a support lug 25 remains on a side that is oriented towards the chipping cavity 20 wherein an insert 22 is supported at the support lug 25 under load. A geometry of the recess 24 and the insert 22 is selected so that a chipping surface 26 extends from a cutting edge 27 of the tooth 19 in one direction to the base of the chipping cavity 20 so that the side surfaces of the chipping cavity 20 are formed by level planes which extend approximately parallel to one another. A wedge angle α of the teeth 19 is 50°, a chip angle β is 26° and a clear angle γ is 14°. Due to the chip angle β being selected rather large compared to conventional circular saw blades the wedge angle α is rather acute which has proven particularly advantageous for cutting material that includes bone.

A depth T of the chip cavities 20, which corresponds to half a difference between an outer diameter of the circular saw blade 7 and a diameter of a circle on which the bases 21 of the chip cavities 20 are arranged amounts to 14.7 mm in the instant embodiment.

It is evident in the sectional view illustrated in FIG. 4 that the circular saw blade 7 has a constant thickness D1 of 4 mm in an inner circular portion KB, whereas it has a constant thickness D2 of 1.3 mm in an outer ring portion RB1. The two side surfaces of the circular saw blade therefore extend in parallel in the two portions recited supra. In portions where the hard metal inserts 22 are arranged the thickness D3 of the circular saw blade is 1.4 mm (c.f. FIG. 5), because the inserts 22 respectively protrude by 0.05 mm on both sides of the circular saw blade 7.

The difference in thickness between the inner circular portion KB and the outer ring portion RB1 of the circular saw blade 7 is caused by the fact that the left side in FIG. 4 extends vertically but the right side respectively extends at a slant angle in upward and downward direction starting from the inner circular portion KB of the circular saw blade 7. Thus, both sides of the circular saw blade 7 in FIG. 4 extend at an angle δ relative to one another in an inner circular portion KB2, thus at an angle 0.5°. This cross sectional geometry surprisingly has the effect that the circular saw blade 7 vibrates less and thus operates quietly. Also omitting the laser incisions 28 (“clefs”) that are provided in the prior art and which are drawn in the circular saw blade 7 in FIG. 1 for illustration purposes and which typically shall have a noise reducing effect, are counterproductive in the circular saw blade 7 according to the invention so that such incisions can and shall be omitted.

FIG. 5 illustrates that the inserts 22 respectively protrude by 0.05 mm on both sides of the circular saw blade 7 where the thickness D3 is 1.4 mm.

FIG. 6a illustrates an enlarged representation of an alternative circular saw blade in a portion of the teeth 19 which have a slightly different geometry compared to the teeth 19 of FIG. 6 so that a circular saw blade of this type only has 100 teeth 19. The teeth 19 have a greater width B of 11 mm, wherein a distance a between adjacent teeth 19 is 20.7 mm. A depth T of the chipping cavity 20 is 15.7 mm. The wedge angle α of the teeth 19 is 65°, the chip angle β 15° and the clear angle γ is 10°. Also the orientation if the inserts 22 differs in FIG. 6a from the orientation of the inserts 22 in FIG. 6.

The inserts 22, which have a length l of 9 mm are inclined so that only their pointed portion at a surface of the teeth 19 is visible and their remaining portion is embedded in the teeth 19. This generates large support lugs 25 where the inserts 22 can be supported under load. The chipping surface 26 of the teeth forms an angle of σ of 30° with a straight back side 53 of the inserts 22. The inserts 22 have a maximum width bₘₐₓ of 3 mm in their cross section and minimum width bₘᵢₙ of 1.5 mm wherein reducing the cross sectional width is performed continuously over a distance s of 4 mm.

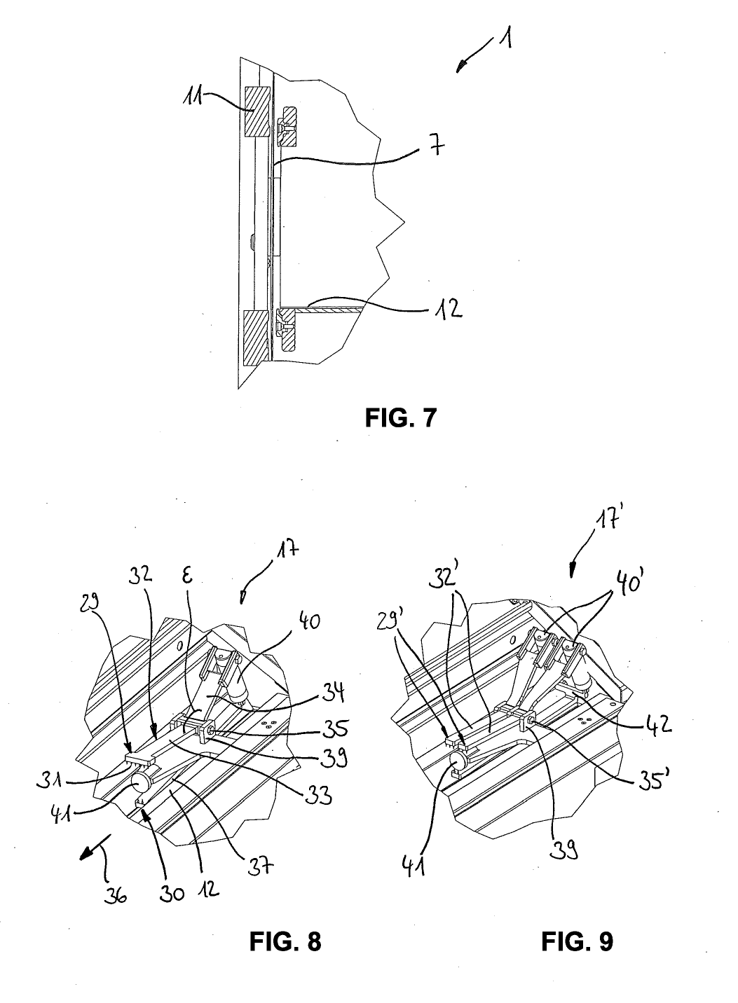

FIG. 7 illustrates a vertical sectional view of the device 1 of FIG. 1 in the portion of the circular saw blade 7, wherein the cutting frame 11, the circular saw blade 7 and the chute base 12 without groove 13 are visible.

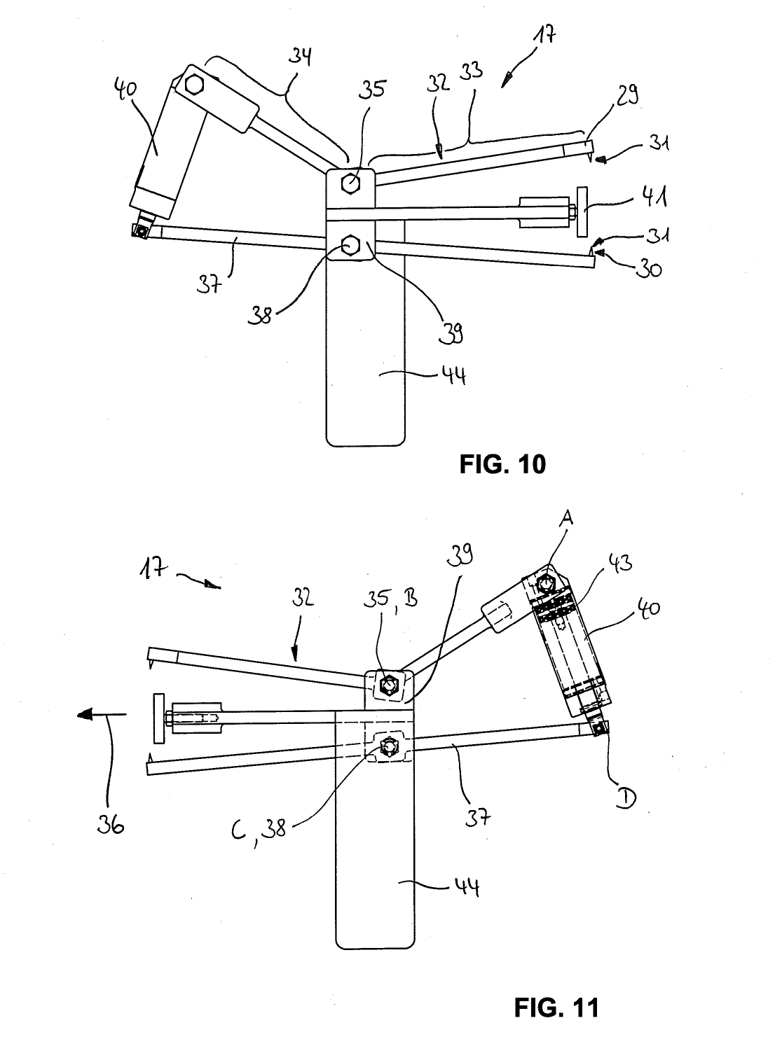

FIG. 8 shows the cutting material support 17 of the device 1 of FIG. 1 which includes an upper engagement element 29 and a lower engagement element 30 wherein the upper engagement element 29 is configured wider and provided with six mandrels 31, whereas the lower engagement element 30 is configured narrower and only has two mandrels 31. The upper engagement element 29 is used for engaging an upper surface of the food product to be cut which upper surface is oriented away from the chute base 12 wherein the food product is not illustrated herein for reasons of clarity. The upper engagement element 29 is arranged at an arm 32 with two sections 33, 34 wherein the two sections 33, 34 of the arm 32 enclose an angle ε with each other. At a kink of the arm 32 the arm 32 is supported at a rotation axis 35 which is oriented perpendicular to a feed direction 36 and parallel to the chute base 12. Also the lower engagement element 30, which is used for engaging a lower surface of the food product 2 to be cut, which lower surface is oriented towards the chute base 12, is provided with an arm 37 which is also supported at an analog rotation axis 38 which is visible in FIG. 10 wherein the arm 37 is configured straight. The two arms 32, 37 are rotatable relative to one another so that the two engagement elements 29, 30 are moveable towards each other or away from each other. The two rotation axes 35, 38 are combined at a bearing block 39 which is in turn is moveable in feed direction 36 by a feed device 44, which is partially illustrated in FIGS. 10 and 11. The engagement elements 29, 30 are configured integral in one piece with the arms 32, 37 which means that a forward, broadened portion of the arms 32, 37 which respectively forms the engagement elements 29, 30 seamlessly transitions into the actual arm 32, 37. Thus, the engagement elements 29, 30 are formed by ends of the arms 32, 37 with mandrels 31 arranged thereon which are oriented towards the food product 2. A drive element 40 is arranged at ends of the respective arms 32, 37 oriented away from the engagement elements 29, 30, wherein the drive element is configured as a piston cylinder unit and pivotably linked to the two arms 32, 37. Thus, the ends are connected by the drive element 40 wherein the distance of the two ends can be varied by the drive element 40 which induces a corresponding movement of the engagement elements 29, 30. The cutting material support 17 is furthermore provided with a stop element 41 where an end of the food product 2 that is oriented away from the cutting device 4, thus the rear end of the food product, comes to rest. The stop element 41 is arranged viewed in feed direction 36 behind the engagement elements 29, 30. Additional details of the cutting material support 17 can be derived from FIGS. 10 and 11.

FIG. 9 illustrates an alternative embodiment of the cutting material support 17′ which includes two upper engagement elements 29′, respectively with three mandrels 31 which respectively include an angled arm 32′ analogous to the arm 32 according to FIG. 8. The two arms 32′ are rotatable about the same rotation axis 35′ which is attached at the bearing block 39. The ends of the arms 32′ that are oriented away from the engagement elements 29′ respectively have a drive unit element 40′ configured as a piston-cylinder-unit, wherein both drive elements 40′ are connected by a transversal strut 42 with the arm 37 of the lower engagement element 30. Providing a two piece upper engagement element 29′ is useful for an application where an upper contour of the food product 2 to be cut is irregular since the two arms 32′ can enclose a different opening angle with the lower arm 37. In this case the two arms 32′ of the upper engagement elements 29′ do not run in parallel.

FIGS. 10 and 11 show the cutting material support 17 of FIGS. 1 and 8 is illustrated in a front view and in a rear view so that the individual elements in both figures are at mirror symmetrical locations. The first engagement element 29 provided as mandrels 31 with an arm 32 made from sections 33, 34 arranged at an angle relative to one another and the second engagement element 30 also configured as mandrels 31 with a straight extending arm 37 are visible particularly well in the figures.

It is evident in particular from FIG. 11 that the two rotation axes 35, 38 of the arms 32, 37 and the two ends of the arms 32, 37 oriented away from the engagement elements 29, 30 wherein the arms are pivotably linked with the piston-cylinder-unit, form a linked rectangle with the link points A, B, C, D wherein the length of the linked rectangle defined by the piston-cylinder-unit is variable within the limitation of the stroke of the piston 43 of the piston-cylinder-unit. The bearing block 39 is moveable by the feed device 44 in and against the feed direction 36.

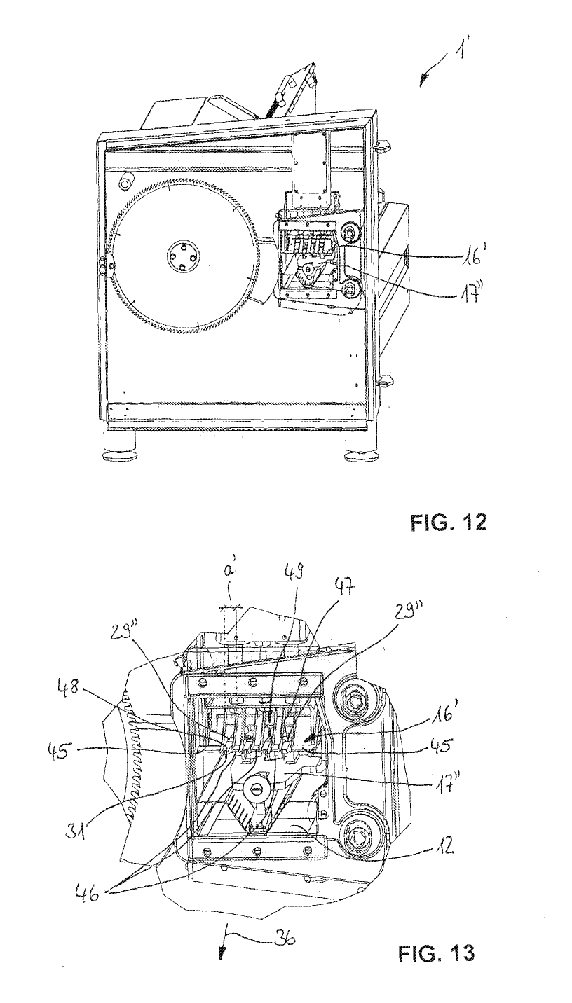

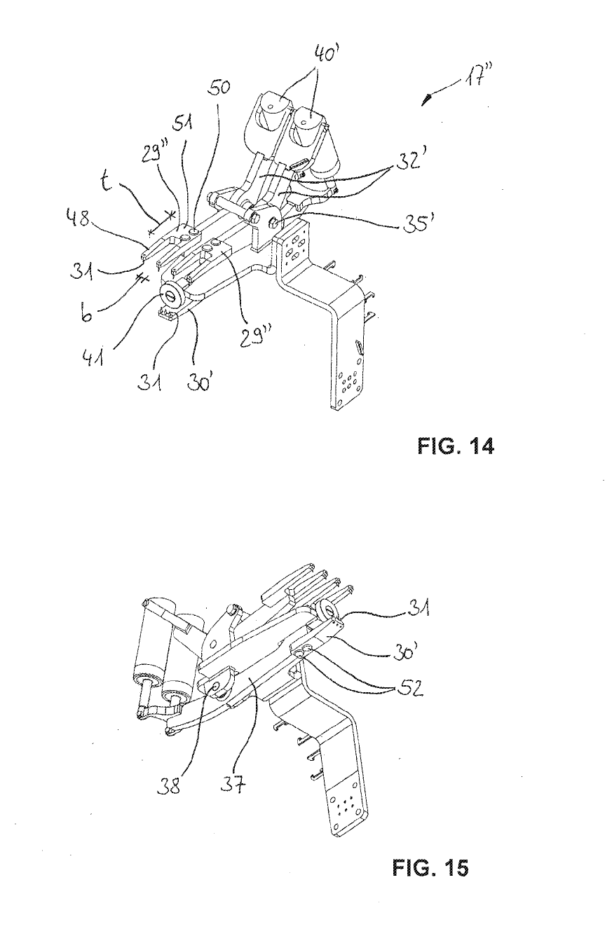

FIG. 12 illustrates and alternative embodiment of the device 1′ for cutting a frozen strand shaped food product 2 into slices wherein the device 1′ differs from the device 1 of FIG. 1 with respect to the configuration of the down holder 16′ and also of the cutting material support 17″ which is evident from FIG. 13. The cutting material support 17″ includes two upper engagement elements 29″ respectively with two mandrels 31 so that the cutting material support 17″ includes a total of four upper mandrels 31. Details of the configuration of the cutting material support 17″ with the upper engagement elements 29″, a lower engagement element 30′, the stop element 41 and the drive elements 40′ is apparent from FIGS. 14 and 15 which are described infra in more detail.

The down holder 16′ illustrated in FIG. 13 has five contact portions 45, 46 through which the down holder 16′ contacts the food product which is not illustrated in FIG. 13 at a surface oriented towards the down holder 16′. The two outer contact portions 45 of the down holder 16′ have greater width than the three remaining contact portions 46 wherein all contact portions 45, 46 are formed by flat steel sections wherein respective struts 47 extend from both sides of the flat steel sections upward in a direction of a top side of the feed portion 5. Adjacent contact portions 45, 46 are arranged offset from one another so that a distance a′ remains in a direction perpendicular to the feed direction 36 and parallel to the chute base 12, wherein the distance a′ exceeds a width b of a finger 48 (c.f. FIG. 14) of the cutting material support 17″ by a few millimeters. The offset arrangement of the contact portions 45, 46 generates recesses 49 between them wherein fingers 48 of the cutting material support 17″ at which the mandrels 31 are arranged can be moved through the recesses 49 though the down holder 16′ is in direct contact with the food product to be cut Thus, it is provided that the end of the food product to be cut which typically only has a very small residual length is pressed down by the down holder 16′ on the one hand side and secured simultaneously by the mandrels 31 of the cutting material support 17″ that engage from above and from below. The cutting material support 17′ and the down holder 16′ thus remain in direct contact with the food product to be cut until a last slice of the food product is cut which significantly improves cutting quality in particular of the last slices.

With respect to embodiments of the down holder 16′ according to the invention numerous alternatives are conceivable, it is only relevant that a free space analogous to the recesses 49 remains between the contact portions 45, wherein the upper engagement elements 29″ of the cutting material support 17″ can move through the free space, though the contact portions 45, 46 of the down holder 16′ are in direct contact or in engagement with the food product to be cut.

FIGS. 14 and 15 respectively illustrate a three dimensional view of the cutting material support 17″ of FIGS. 12 and 13 wherein FIG. 13 shows a view from above and FIG. 14 shows a view from below. The basic configuration of the cutting material support 17″ corresponds to the configuration of the cutting material support 17 or 17′ from FIGS. 8-11 with a stop element 41, one or two upper engagement elements 29″, a lower engagement element 30′ wherein the engagement elements 29″, 30′ are respectively connected by arms 32′, 37 with a rotation axis 35′, 38 or a drive element 40′. As a difference over FIGS. 8-11 the engagement elements 29″, 30′ according to FIGS. 14 and 15 are configured as elements that are separate from the arms 32′, 37 which can be connected through disengage able connection devices 50, namely threaded connections with the arms 32′, 37. This is advantageous since this way various engagement elements 29″, 30′ can be used as a function of the food product to be cut, wherein a switching of the engagement elements is performed by simple disengagement and tightening of bolts. Alternatively it is conceivable to connect the engagement elements with the arms through disengage able plug in connections. A connection through a magnetic effect of the engagement elements and/or the arms is also feasible.

The two upper engagement elements 29″ are respectively configured horse shoe shaped or they are U-shaped, wherein a mandrel 31 is arranged at ends of two elongated fingers 48 wherein the mandrel 31 engages the food product to be cut during the feed process. A base 51 of the U-shaped engagement element 29″ has a large depth t so that the connection devices for attaching the engagement element 29″ at the arm 32′ are arranged at this location.

The lower engagement element 30′ whose configuration is evident from FIG. 15 is made from flat steel and connected with the arm 37 by bolts 52 at its end oriented towards the arm 37 and provided with three mandrels 31 at its end oriented away from the arm 37.

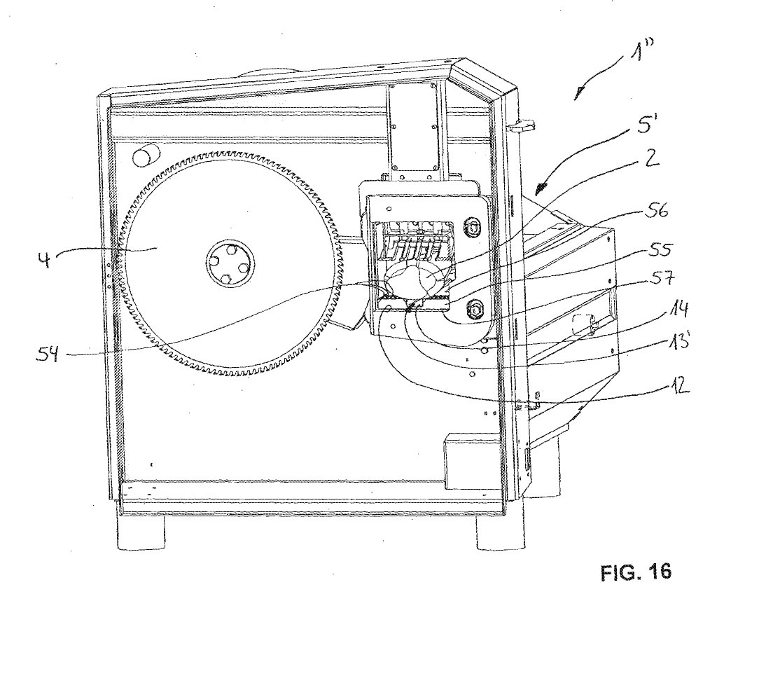

Last not least FIG. 16 illustrates an alternative device 1″ for cutting a frozen, strand shaped food product 2 into slices, wherein only the feed portion 5′ of the device differs from the device 1 of FIG. 1. The device 1″ namely includes a chute insert 55 that is arranged on the chute base 12 wherein the chute insert has a cross section of a rectangular hollow element and a top side 56 and a bottom side 57. The top side 56 and the bottom side 57 extend parallel to one another and parallel to the chute base 12. Only in a center portion of the top side 56 a groove 13′ with a rectangular cross section is recessed wherein a groove base 14′ is only a few centimeters wide. The food product 2 accordingly mainly rests on the top side 56 of the chute insert 55 extending parallel to the chute base 12 wherein the chute insert is configured with elongated ribs 54 which extend parallel to one another and also parallel to the feed direction 36 and respectively have a length of a few centimeters. The ribs form small protrusions which provide good grip for an end of the food product 2 that is oriented towards the cutting device so that a rotation of the frozen food product 2 is counteracted.

### REFERENCE NUMERALS AND DESIGNATIONS

1, 1′, 1″ device
2 food product
3 machine frame
4 cutting device
5, 5′ feed portion
6 cutting tool
7 circular saw blade
8 center axis
9 arm (swing arm)
10 cross (fixed rotation axis)
11 cutting frame
12 chute base
13, 13′ groove
14, 14′ groove base
15 groove top side
16, 16′ down holder
17, 17′, 17″ cutting material support
18 front end of food product
19 tooth
20 chipping cavity
21 base
22 insert
23 base section
24 recess in tooth
25 support lug
26 chipping surface
27 cutting edge
28 laser incision
29, 29′, 29″ upper engagement element
30, 30′ lower engagement element
31 mandrel
32, 32′ arm (upper)
33, 34 section
35, 35′ rotation axis
36 feed direction
37 arm (lower)
38 rotation axis
39 bearing block
40, 40′ drive element
41 stop element
42 transversal strut
43 piston
44 feed device
45, 46 contact portion
47 strut
48 finger
49 recess
50 connection device
51 base
52 bolt
53 back side of insert
54 rib
55 chute insert
56 top side
57 bottom side
A, B, C, D link point
L length of chute base
l length of insert
M center
T, t depth
D diameter
a, a′ distance
B width of tooth
b width
t depth of base
s distance
bₘₐₓ maximum width
bₘᵢₙ minimum width
D1, D2, D3 thickness
KB circular portion
RB1 outer ring portion
RB2 inner ring portion
α wedge angle
β chip angle
γ clear angle
δ angle
ε angle
σ angle

What is claimed is:

1. A device for cutting a frozen food strand into slices, the device comprising:
a machine frame;
a cutting device with a cutting tool configured as a circular saw blade supported in or at the machine frame, wherein the cutting tool is rotatable about its center axis and moveable in a cutting plane defined by the circular saw blade; and
a feed portion for the food product to be cut from which feed portion the food product is moveable towards the cutting device so that successive slices are cutable from the food product wherein the food product is moveable in the feed portion in a feed direction which extends perpendicular to the cutting plane,
wherein the circular saw blade is supported drivable in rotation at an arm that is supported in or at the machine frame, and
wherein the circular saw blade continuously rotates or oscillates with the arm about a rotation axis of the arm which rotation axis is fixated at the machine frame.

2. The device according to claim 1,
wherein a thickness of the circular saw blade in a ring portion which extends from an outer diameter of the circular saw blade by 20 mm to 30 mm radially in a direction towards the center axis of the circular saw blade is less than 2 mm, and
wherein a diameter of the circular saw blade is advantageously greater than 500 mm.

3. The device according to claim 1,
wherein a largest width of teeth measured in a circumferential direction of the circular saw blade is less than 20 mm, and
wherein a distance of cutting edges of respective adjacent teeth is less than 22 mm.

4. The device according to claim 1, wherein a chipping surface extending from a cutting edge of a tooth is in alignment with or in a common plane with a front surface of the respective tooth, the front surface adjoining in a direction towards a base of a chipping cavity.

5. The device according to claim 1,
wherein a chipping surface extending from the cutting edge of a tooth encloses a first angle with a back side of an insert which back side is oriented away from the chipping cavity, and
wherein the first angle is between 25° and 35°.

6. The device according to claim 1, wherein a difference between an outer diameter of the circular saw blade and a diameter of a circle on which bases of the chip cavities are arranged is at least 20 mm.

7. The device according to claim 1,
wherein a side surface of the circular saw blade that is oriented towards a slice that is being cut from the food product extends at a second angle between 2° and 0.2° relative to an opposite side surface of the circular saw blade so that a thickness of the circular saw blade decreases in a radially outward direction, and
wherein an opposite side surface of the circular saw blade advantageously extends at an angle of 90° relative to the rotation axis.

8. The device according to claim 1,
wherein the circular saw blade has parallel side surfaces in an outer ring portion that extends from an outer diameter of the circular saw blade radially in a direction towards the center axis and in an inner circular portion which extends from a center point of the circular saw blade in radially outward direction, and
wherein side surfaces of the circular saw blade in an inner ring portion which extends between the outer ring portion and an inner circular portion are inclined relative to each other.

9. The device according to claim 1, wherein hard metal inserts protrude in axial direction beyond at least one of the two side surfaces of the circular saw blade advantageously by an amount between 0.05 mm and 0.25 mm.

10. The device according to claim 1, further comprising: an automatic switch off or a device for reducing an angular velocity of the arm that is activatable when a threshold value for a resistance of the arm during chipping engagement of the circular saw blade in the food product is exceeded.

11. A method for cutting a frozen food product strand into slices, the method comprising the steps:
inserting the food product to be cut in a feed portion of a device for cutting;
moving the food product out of the feed portion forward to a cutting device of the device so that successive slices are cut off by a cutting tool configured as a circular saw blade from the product at its forward end;
rotating the circular saw blade about its center axis and moving it in a cutting plane defined by the circular saw blade; and
moving the food product in a feed direction that extends perpendicular to the cutting plane during feeding,
wherein an arm which supports the center axis of the circular saw blade is rotated about a rotation axis that is fixated at the machine frame, or
wherein the arm performs an oscillating movement about the rotation axis.

12. The method according to claim 11,
wherein a speed of the circular saw blade is selected relative to a speed of the arm at least large enough so that a volume of chips that is generated by a pass through of a tooth through a saw gap generated in the food product to be cut has a volume that is smaller than a volume of a chipping cavity that is arranged between two adjacent teeth, and
wherein the speed of the circular saw blade is advantageously greater than 1800 rpm.

13. The method according to claim 11,
wherein a rotation or oscillating movement of the arm is switched off when exceeding a threshold value for a resistance of the arm when the circular saw blade passes through the food product, or
wherein the speed or an angular velocity of the arm is reduced when exceeding a threshold value for a resistance of the arm when the circular saw blade passes through the food product.

14. The method according to claim 11, wherein a ratio of the speed of the circular saw blade to the speed of the arm is at least 15:1.
